(19) United States
(12) Patent Application Publication
(10) Pub. No.: US 2013/0263156 A1
(43) Pub. Date: Oct. 3, 2013

(54) OPERATION LOG COLLECTION METHOD AND DEVICE

(71) Applicants: Hiromitsu Nakagawa, Yokohama (JP); Tomohiro Nakamura, Hachioji (JP); Tomotaka Shionoya, Yokohama (JP); Takao Sakurai, Tokyo (JP); Yukihisa Fujita, Yokohama (JP)

(72) Inventors: Hiromitsu Nakagawa, Yokohama (JP); Tomohiro Nakamura, Hachioji (JP); Tomotaka Shionoya, Yokohama (JP); Takao Sakurai, Tokyo (JP); Yukihisa Fujita, Yokohama (JP)

(73) Assignee: HITACHI, LTD., Tokyo (JP)

(21) Appl. No.: 13/819,970

(22) PCT Filed: Jan. 31, 2011
(86) PCT No.: PCT/JP2011/051950

§ 371 Date: May 2, 2013

(30) Foreign Application Priority Data
Dec. 24, 2010 (JP) 2010-286909

(51) Int. Cl. G06F 9/54

(52) U.S. Cl. CPC G06F 9/542
USPC 719/318

(57) ABSTRACT

In order to evaluate the service quality of an application, there are methods which acquire various types of events which occur upon a Web browser upon which an application is operating in order to analyze thereof. On this occasion, if all events are acquired/collected, a load is placed thereby upon the Web browser or a server which records the events. In the present invention, when the Web browser starts the application, a connection is made to an event handler which acquires events related to user operations or application responses. When the event handler detects the occurrence of an event, if the event has not been recorded in the past, the event is recorded as a log. In the case of another event, in case a script has been executed or in case data has been modified, the event is recorded as a log.

### TECHNICAL FIELD

The present invention relates to a method and a device for collecting operation logs of Web applications. More particularly, the invention relates to a method and a device for reducing the amount of collected operation logs.

### BACKGROUND ART

In recent years, online services based on Web applications have gained widespread acceptance in diverse business types such as financing and retailing. More and more corporations are offering online services year by year; Web applications have become indispensable to corporate activities. One reason such online services are being offered is that they can bring in new customers on a wide scale. Each corporation can offer online services free of the constraints of time and location, so that users have a wide range of services to choose from.

Against this background, the quality of service has become important. For example, if the quality of service is low, as when a Web application is slow to respond or when the desired service menu is difficult to find, the users look for other online services, resulting in a loss of business opportunities. Thus the corporations need to maintain and improve the quality of their services. To maintain and improve the quality of service requires two measures: one involving monitoring the quality of service, and the other involving rapidly boosting the quality of service if it is found low.

The present invention relates to the measure for monitoring the quality of service.

The measure for monitoring the quality of service includes, among others, a method for collecting and analyzing the access logs of Web application servers offering Web applications, and a method for collecting and analyzing Web application operation logs from clients. With regard to the latter method, this invention relates in particular to an operation log collection and reproduction device that collects Web application operation logs from clients and reproduces the screens of the clients on the side of a service provider so as to analyze what operations its users have performed and how the applications have responded to the users' operations.

In collecting operation logs necessary for the reproduction of screens, the operation log collection and reproduction device places an operation recording script to a given client and thereby acquires event messages stemming from application operations on the client so as to create and collect operation logs. In this case, if the operation logs of all events are simply collected, the amount of logs can become inordinately large and prove to be burdensome on the recording media of the service provider being analyzed.

A related technique for reducing the amount of collected logs has been proposed (e.g., Patent Literature 1) whereby analyzers set a log collection policy on the target system so as to customize the types of events regarding the logs to be collected.

### CITATION LIST

### Patent Literature

PTL 1: Japanese Patent Application Laid-Open Publication No. 2009-25977

### SUMMARY OF INVENTION

### Technical Problem

The related art technique described in the above-cited Patent Literature 1 involves setting flags to determine whether or not diverse types of events taking place on the Web browser of a given client are to be recorded as logs. When this technique is used to reproduce the screen of the client, the following problem is experienced: To reproduce the client screen requires collecting all events regarding the user's operations and the responses of the application of interest that can change the screen in any way. The events that need to be collected to reproduce the client screen are only part of tens to hundreds of events. However, the types of events necessary for reproducing the client screen vary from one application to another. This makes it difficult for the analyzers to determine exactly which of the tens to hundreds of events need to be collected. As a result, the analyzers have no choice but to determine that all events except for those deemed unnecessary in view of the installed applications are to be collected. This will not contribute to reducing the amount of collected logs. Also, in order to acquire events having occurred on the Web browser, a program (called the event handler) for detecting the generation of such events and recording the detected events is usually connected. If this program is executed regarding the generation of all events, the load on the client can become so large as to prevent its user from performing operations.

Thus the problem is how to automatically determine the types of events necessary for reproducing the client screen and how to establish means for acquiring and collecting an amount of logs necessary and sufficient for screen reproduction. The amount of logs necessary and sufficient for screen reproduction means the amount of recorded logs about the events associated with user operations and application responses that change the screen in any way.

### Solution to Problem

When a Web browser starts an application, an event handler is connected to acquire events associated with user operations and application responses. Upon detecting generation of an event, the event handler records the event as a log if the detected event has not been recorded in the past. If the event is of some other type, if a script has been executed, or if data has been changed, the event handler records the event in question as a log.

When the event handler above is connected, the necessary types of events may be registered beforehand as a policy. Detection and recording of events may then be performed only with regard to the registered types of events. Furthermore, a list of the types of events recorded in the past with regard to the application targeted for analysis may be acquired as operation information that may be used as the initial values of the policy.

### Advantageous Effects of Invention

According to an aspect of the present invention, it is possible to acquire and collect the amount of logs necessary and sufficient for reproducing client operations while reducing the amount of the collected logs. Also according to an aspect of the invention, the user can precisely set with a minimum of effort a log collection policy for determining whether or not to record logs.

### BRIEF DESCRIPTION OF DRAWINGS

FIG. 1 is a block diagram showing a basic configuration of a Web system targeted by this invention.

FIG. 2 is a block diagram showing the typical functions configured in an operation log collection device as a first embodiment of this invention.

FIG. 3 is a flowchart representing a typical process performed by a program initialization unit in FIG. 2.

FIG. 4 is a flowchart representing a typical process performed by an operation log recording unit in FIG. 2.

FIG. 5 is a typical event log used by the operation log recording unit in FIG. 2 for creating an operation log.

FIG. 6 is a typical operation log created by the operation log recording unit in FIG. 2.

FIG. 7 is a flowchart representing a typical process performed by an operation log reading unit in FIG. 2 to read and transmit an operation log to a Web server.

FIG. 8 is a block diagram showing the typical functions configured in an operation log collection device as a second embodiment of this invention.

FIG. 9 is a tabular view showing a typical structure of a log collection policy table for creating an operation log collection code in FIG. 8.

FIG. 10 is a flowchart representing a typical process performed by an operation log collection code setting program in FIG. 8 for setting a log collection policy.

FIG. 11 is a flowchart representing a typical process performed by a script selection and insertion program in FIG. 8 for inserting the operation log collection code into an application code.

FIG. 12 is a schematic view showing a typical user interface for setting the log collection policy in FIG. 9.

FIG. 13 is a typical flowchart representing a typical process performed by an operation log recording/operation information recording unit in FIG. 8.

FIG. 14 is a schematic view showing a typical structure of an application operation information table created by an application operation information creation unit in FIG. 8.

FIG. 15 is a flowchart representing a typical process performed by the application operation information creation unit in FIG. 8 for updating operation information.

FIG. 16 is a flowchart representing a typical process performed by an application operation information reading unit in FIG. 8 for reading application operation information so as to transmit the read information to a Web server.

### DESCRIPTION OF EMBODIMENTS

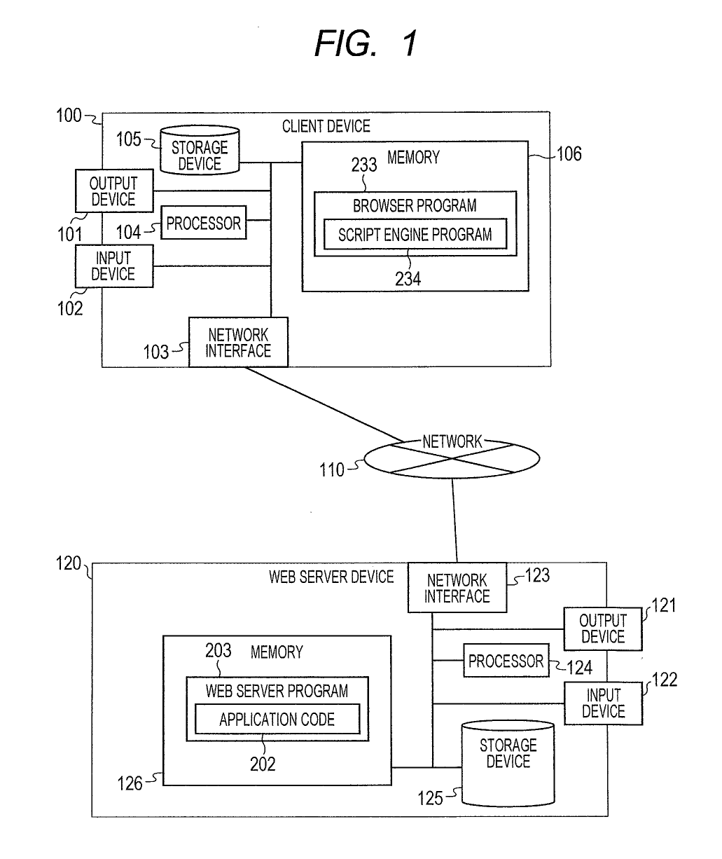

Some embodiments of the present invention are explained below by successively referring to FIGS. 1 through 16.

### First Embodiment

FIG. 1 is a system configuration diagram showing a typical hardware configuration and a typical software configuration of a system which executes Web applications and which is targeted by this invention.

The system hardware is made up of a client device 100, a Web server device 120, and a network 110 for connecting these devices. Each of the devices may be implemented using either an integral piece of hardware or a plurality of pieces of hardware. There may be provided a plurality of client devices connected to a single Web server device.

The client device 100 and Web server device 120 each possess a processor (104, 124), a memory (106, 126), an input device (102, 122), an output device (101, 121), a network interface (103, 123), and a storage device (105, 125) interconnected with one another. Some of these component elements may not be part of some devices. The storage device 105 may be included in the memory 106, and the storage device 125 may be included in the memory 126.

A keyboard, a mouse, or the like, are connected to the input device 102 that is used to give instructions to execute and stop programs. A monitor, a printer, or the like, are connected to the output device 101 that is used to display the result of program execution. The processor 104 reads programs from the memory 106 and executes the read programs. The network interface 103 is a device that connects the client device 100 with an external device. The network interface 103 exchanges Web page requests and responses with the Web server device 120 by way of the network 110.

A browser program 233 is stored in the memory 106 of the client device 100. A script engine program 234 is included in the browser program 233. Any one of these programs may contain the others or each of them may be provided independently. These programs are read and executed by the processor 104.

The browser program 233 has, among others, the function of requesting Web pages, receiving responses from the requested Web page, and creating a display screen by interpreting the received responses. The script engine program 234 has the function of interpreting the script code included in the responses of the Web page and causing the processor 104 to execute the processes described in the script code.

The memory 126 of the Web server device 120 stores a Web server program 203. An application code 202 is included in the Web server program 203. These programs and codes may each contain the others or may each be provided independently. These programs and codes are read and executed by the processor 124.

The Web server program 203 has the function of returning Web page responses to requests from external devices such as the client device 100. The application code 202 is a code that is executed by the browser program 233 of the client device 100. As such, the application code 202 is included in the responses returned by the Web server program 203.

The storage device 105 stores, among others, operation logs exchanged between the client device 100 and the Web server device 120.

The output device 121, input device 122, processor 124, network interface 123, and storage device 125 have the same functions as their counterparts having same names in the client device 100.

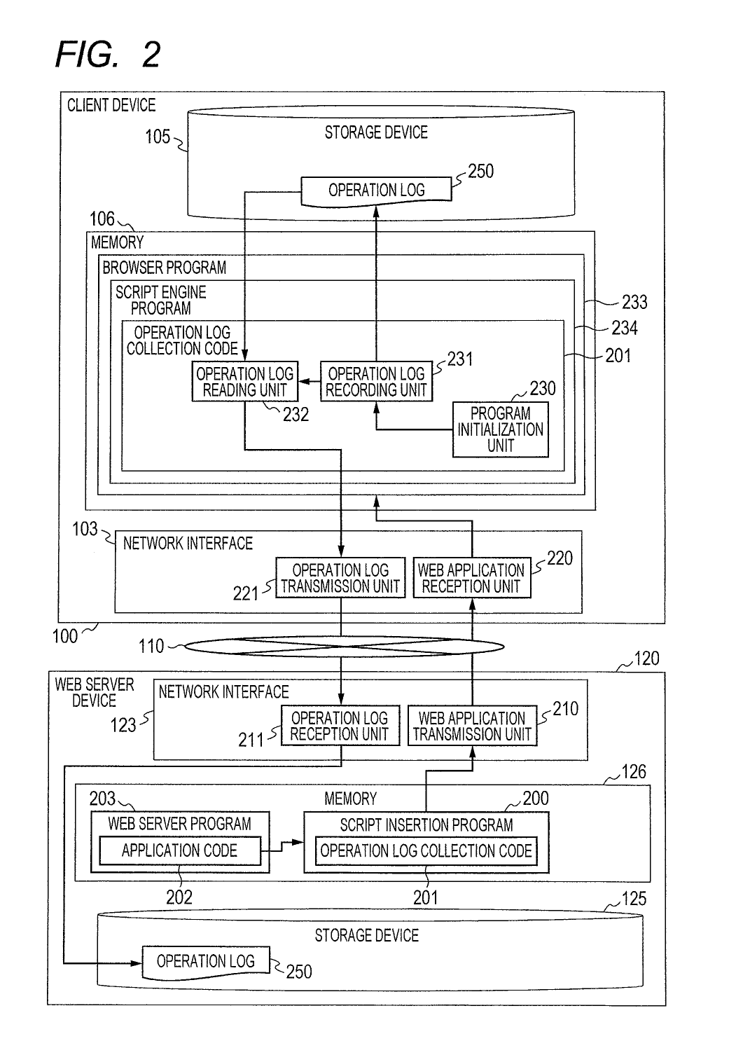

FIG. 2 is a block diagram showing a software structure for selectively transmitting the amount of event logs necessary and sufficient for reproducing client operations based on the logs.

The memory 126 of the Web server device 120 stores a script insertion program 200 in addition to the Web server program 203 and application code 202. Also, an operation log collection code 201 is included in the script insertion program 200. These programs and codes may each contain the others or may each be provided independently.

The script insertion program 200 has the function of receiving responses including the application code 202 from the Web server program 203 and inserting the operation log collection code 201 into the application code 202, before returning a response to the client via a Web application transmission unit 210. The operation log collection code 201 has the function of recording logs of events on the client device 100 and transmitting the recorded logs to the Web server device 120.

The network interface 123 of the Web server device 120 is made up of an operation log reception unit 211 and the Web application transmission unit 210.

The operation log reception unit 211 has the function of receiving an operation log 250 from an operation log transmission unit 221 of the client device 100 via the network 110 and storing the received log into the storage device 125. The Web application transmission unit 210 has the function of receiving a Web application response from the script insertion program 200 and transmitting the received response to a Web application reception unit 220 of the client device 100 via the network 110.

Following receipt of the Web page response, the memory 106 of the client device 100 stores the operation log collection code 201 in addition to the browser program 233 and script engine program 234. The operation log collection code 210 is made up of a program initialization unit 230, an operation log recording unit 231, and an operation log reading unit 232, each unit being executed by the processor 104 in FIG. 1. These programs may be constituted alternatively by a plurality of programs having equivalent functions.

The program initialization unit 230 has the function of granting the script engine program 234 a process of creating an event log upon acquisition of events on the browser program 233 and a process of acquiring execution of an event-driven script. In this context, an “event” refers to what takes place during application execution, such as a click of the mouse or input of a value into a Web page. The function of the program initialization unit 230 is performed only once immediately before the content included in the response from the Web server program 203 is displayed.

The operation log recording unit 231 has the function of detecting solely the events determined to involve data updates or the events determined to entail script execution from among the events having occurred on the browser program 233, and recording the detected events chronologically to the storage device 105 as the operation log 250. The operation log collection code 201 is implemented as a script code executable by the script engine program 234. Every time an event takes place on the browser program 233, the operation log collection code 201 is executed by the script engine program 234.

The operation log reading unit 232 has the function of reading all operation logs 250 stored in the storage device 105 and transferring the retrieved logs to the operation log transmission unit 221. The transmitted operation logs 250 are recorded to the storage device 125 of the Web server device 120.

The network interface 103 of the client device 100 is made up of the operation log transmission unit 221 and Web application reception unit 220.

The operation log transmission unit 221 has the function of receiving the operation log 250 from the operation log reading unit 232 and transmitting the received log to the operation log reception unit 211 of the Web server device 120 via the network 110. The Web application reception unit 220 has the function of receiving a Web application response from the Web application transmission unit 210 of the Web server device 120 via the network 110 and transferring the received response to the browser program 233.

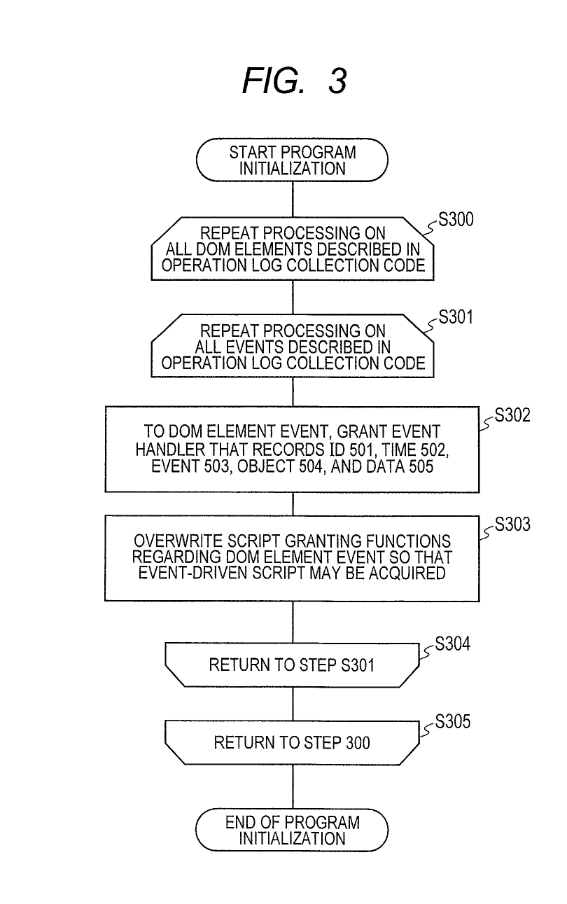

FIG. 3 shows a processing flow of the program initialization unit 230.

As indicated in steps S300, S301, S304 and S305 of FIG. 3, the program initialization unit 230 repeats steps S302 and S303 on all DOM (Document Object Model) elements described in the operation log collection code and on all events also described therein.

In step S302, an event of a DOM element is granted an event handler for recording an ID 501, a time 502, an event 503, an object 504, and data 505. Granting of the event handler is implemented using functions possessed by a DOM object, for example.

In step S303, script granting functions for DOM element events are overridden. Overriding of the script granting functions is implemented, for example, by overwriting attach-event functions and add-event listener functions possessed by the DOM object with functions having the same names. This makes it possible to add a process of generating an appropriate message when an event-driven script operation defined by an application is executed. That in turn makes it possible, upon generation of an event during the subsequent application operation, to determine whether an event-driven script has been executed.

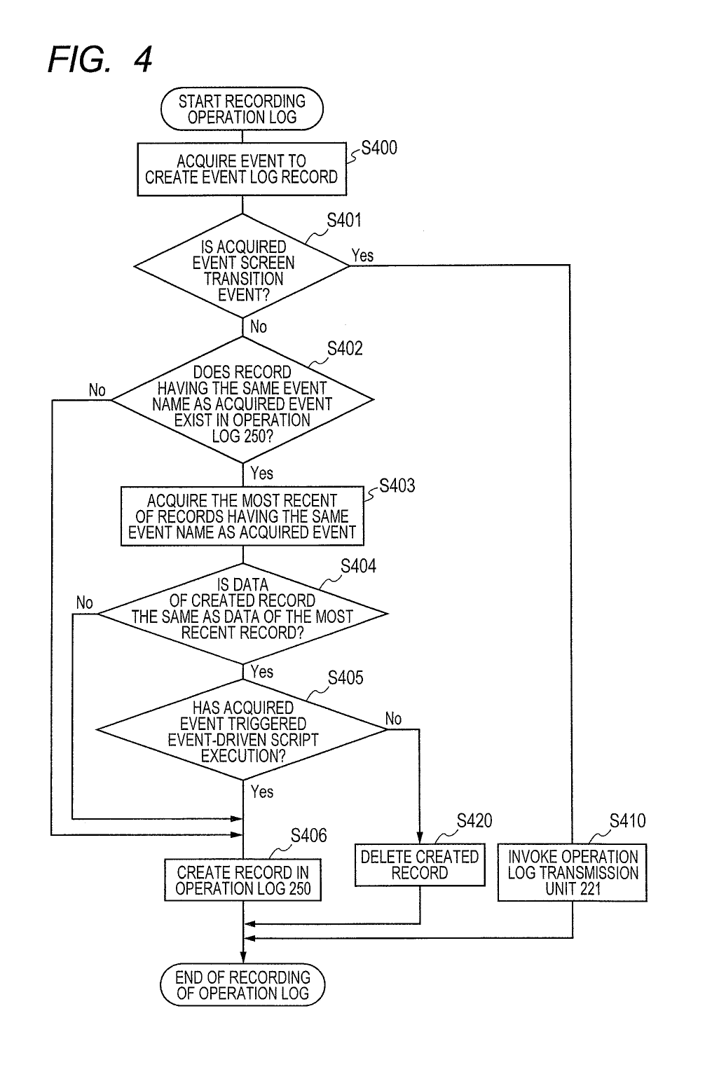

FIG. 4 shows a processing flow of the operation log recording unit 231.

First in step S400, a generated event is acquired and an event log record is created. In step S401, it is determined whether the acquired event is a screen transition event. The screen transition event refers to an event which, upon its generation, entails transmission of a request to the Web server program 203 or receipt of a response therefrom. In this case, the event to be determined need not be the screen transition event; it may alternatively be some other event such as a mouse operation event or a key operation event. In this case, if the screen transition event is targeted for the determination, it is possible to prevent the event log records in the memory 106 from getting released and lost as a result of page transition. Also, a branch to step S410 may take place not upon acquisition of a screen transition event but upon every elapse of a predetermined time period following start of the recording of an operation log.

If the generated event is a screen transition event, then step S410 is reached. In step S410, the operation log transmission unit 221 is invoked, and this process is terminated.

If the generated event is not a screen transition event, step S402 is reached. In step S402, it is determined whether any record having the same event name as the acquired event exists in the operation log 250. This determination can leave as a record the time at which each event occurred for the first time and which is needed for screen reproduction. If any record having the same event name 503 as the acquired event is determined not to exist in the operation log 250, step S406 is reached. In step S406, the record is created in the operation log 250, and this process is terminated.

If records having the same event name as the acquired event are determined to exist in the operation log 250, step S403 is reached. In step S403, the most recent of the records having the same event name is acquired.

Next in step S404, it is determined whether the data 505 of the acquired record is the same as the data 505 of the record created in step S400. At this time, the two bodies of data may be determined to be different if any value is found different therebetween or if the difference between the two bodies of data is found larger than a predetermined degree of difference. With this embodiment, the mouse coordinates in effect upon generation of an event are recorded in the form of X and Y coordinates as data about “mouseover,” “mousemove” and “mouseout” events. With regard to these events, the two bodies of data are determined to be different if the X or Y coordinate has a difference of 10 or more between the two. Also, with regard to “focus,” “cookie” and “userdata” events, the two bodies of data are determined to be different if any difference at all is detected therebetween. This determination can leave as a record the time at which a data change occurred and which is needed for screen reproduction. If the data 505 of the acquired record is different from the data 505 of the record created in step S400, step S406 is reached. In step S406, the record is created in the operation log, and this process is terminated.

If the data 505 of the acquired record is the same as the data 505 of the record created in step S400, step S405 is reached. In step S405, it is determined whether the acquired event has triggered event-driven script execution. Whether or not event-driven script execution has occurred is determined by acquiring the message defined beforehand in step S303 of FIG. 3. This determination can leave as a record the time at which an event having triggered script execution occurred and which is needed for screen reproduction. If the acquired event has not triggered event-driven script execution, step S420 is reached. In step S420, the record created in step S400 is deleted, and this process is terminated.

If the acquired event is determined to have triggered event-driven script execution, step S406 is reached and a record is created in the operation log 250.

When the determinations are carried out in step S402, S404 and S405 as described above, it is possible to delete in step S420 those records not necessary for screen reproduction. The records unnecessary for screen reproduction are those records created upon generation of events of which the types have already been recorded, which entail no data change and which have not triggered script execution. It is determined in step S402 whether the event in question is of a type already recorded in the operation log; in step S404 whether the event of which the type has been recorded in the operation log entails any data change, and in step S405 whether the event of which the type has been recorded in the operation log and which entails no data change has triggered script execution. In this manner, the Web server device can reproduce client operations while the amount of logs to be stored in the client device preparatory to log data transmission to the Web server device is reduced.

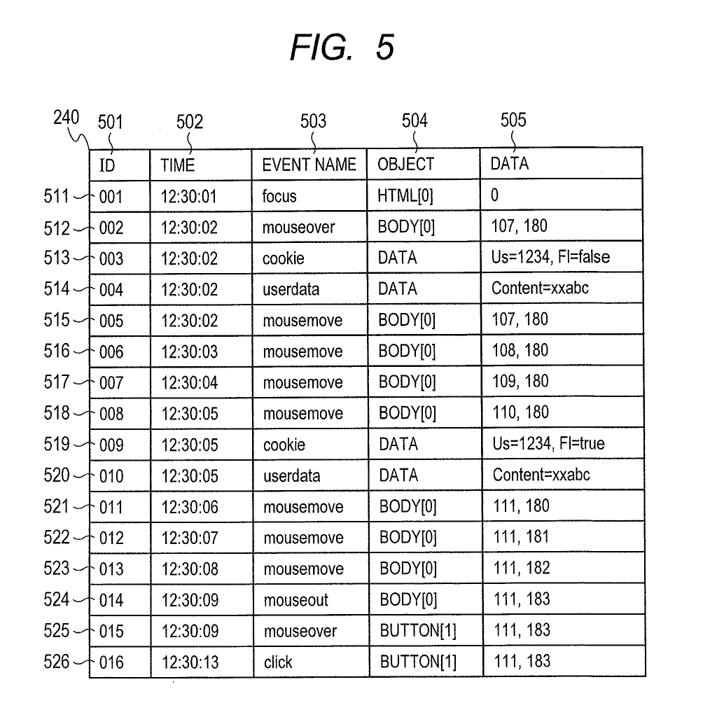

FIG. 5 is a schematic view of a typical event log created temporarily by the operation log recording unit 231. An event log is created in the form of records such as those 511 through 526 each created every time an event is generated. The records 511 through 526 each have an ID 501, a time 502, an event 503, an object 504, and data 505 in their respective columns.

The ID 501 uniquely identifies each record in the event log. Whereas three-digit integer values are listed in the ID column of FIG. 5, the ID may also be a character string or a symbol as long as it uniquely identifies each record.

The time 502 denotes the time of day at which an event occurred. Whereas the time expression in “hh:mm:ss” form is used in the time column of FIG. 5, some other suitable form of time expression may be used instead as long as it correctly identifies the time of day.

The event name 503 denotes the name of a generated event. Some other suitable form of event name expression may be used instead if it correctly identifies the event name. The events explained above as having the same names in reference to FIG. 4 are exemplified by events 512, 515, 516, 517, 518, 521, 522, 523, 524 and 525 in FIG. 5.

The object 504 denotes the thing on which an event occurred. Whereas FIG. 5 lists Web page DOMs and data as typical objects, other objects may be recorded instead. Some other suitable form of object expression may also be used if it correctly identifies the object.

The data 505 denotes the input/output data accompanying the events. Whereas FIG. 5 lists as typical data the coordinates in which events occurred and the data changed by events, other input/output data may be recorded instead. Some other suitable form of data expression may also be used if it correctly identifies the data.

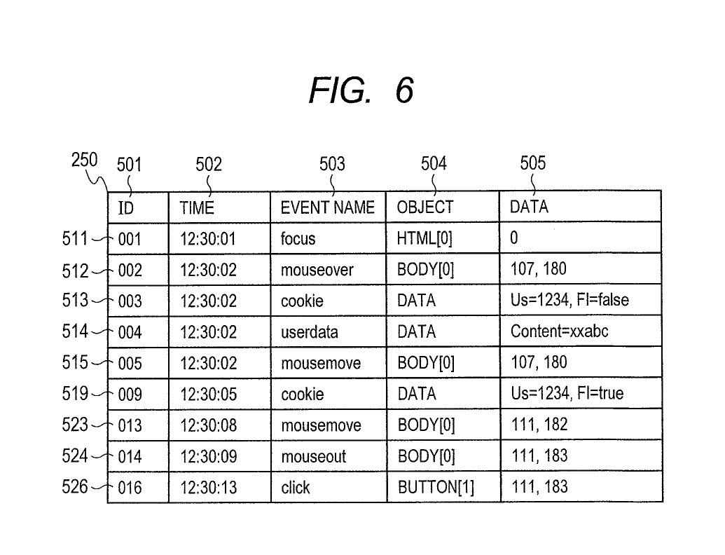

FIG. 6 is a schematic view of a typical operation log 250 created following selection of the amount of log data necessary and sufficient for reproducing client operations from event logs through the flow of FIG. 4.

The ID 501, time 502, event name 503, object 504, and data 505 in FIG. 6 are the same as their counterparts denoted by the same numerals in FIG. 5. FIG. 6 shows an example in which, of the records 511 through 526 listed in FIG. 5, those denoted by numerals 511, 512, 513, 514, 515, 519, 523, 524 and 526 have been selected through the flow of FIG. 4. Comparing the examples reveals that the amount of collected logs has been reduced.

The record 511 in FIG. 5 is recorded when the record “focus” having the same event name is determined not to exist in the operation log 250 of FIG. 6 in step S402 of FIG. 4. The record 512 in FIG. 5 is recorded when the record “mouseover” having the same event name is also determined not to exist in the operation log 250 of FIG. 6 in step S402 of FIG. 4. The record 513 in FIG. 5 is recorded when the record “cookie” having the same event name is also determined not to exist in the operation log 250 of FIG. 6 in step S402 of FIG. 4. The record 514 in FIG. 5 is recorded when the record “userdata” having the same event name is also determined not to exist in the operation log 250 of FIG. 6 in step S402 of FIG. 4. The record 515 in FIG. 5 is recorded when the record having the same event name is also determined not to exist in the operation log 250 of FIG. 6 in step S402 of FIG. 4.

The records 516 through 518 in FIG. 5 are deleted when, in step S402 of FIG. 5, a record having the same event name “mousemove” is determined to exist as the record 515 in the operation 250 of FIG. 6; when these records have the same data as the record 515 in step S404, and when event-driven script execution is determined not to have occurred in step S405.

The record 519 in FIG. 5 is recorded when, in step S402 of FIG. 5, a record having the same event name “cookie” is determined to exist as the record 513 in the operation log 250 of FIG. 6, and when the record 519 is determined to have different data than the record 513 in step S404. The record 520 in FIG. 5 is deleted when, in step S402 of FIG. 5, a record having the same event name “userdata” is determined to exist as the record 514 in the operation log 250 of FIG. 6; when the record 520 is determined to have the same data as the record 514 in step S404, and when event-driven script execution is determined not to have occurred in step S405. The records 521 and 522 in FIG. 5 are deleted when, in step S402 of FIG. 5, a record having the same event name “mousemove” is determined to exist as the record 515 in the operation log 250 of FIG. 6; when the records 521 and 522 are determined to have the same data as the record 515 in step S404, and when event-driven script execution is determined not to have occurred in step S405.

The record 523 in FIG. 5 is recorded when, in step S402 of FIG. 5, a record having the same event name “mousemove” is determined to exist as the record 515 in the operation log 250 of FIG. 6; when the record 523 is determined to have the same data as the record 515 in step S404, and when event-driven script execution is determined to have occurred in step S405. This example is based on the assumption that “mousemove” event-driven script execution occurred at the time of 12:30:08.

The record 524 in FIG. 5 is recorded when, in step S402 of FIG. 4, any record having the same event name “mouseout” is determined not to exist in the operation log 250 of FIG. 6. The record 525 in FIG. 5 is deleted when, in step S402 of FIG. 5, a record having the same event name “mouseover” is determined to exist as the record 512 in the operation log 250 of FIG. 6; when the record 525 is determined to have the same record as the record 512 in step S404, and when event-driven script execution is determined not to have occurred in step S405.

The record 526 in FIG. 5 is recorded when, in step S402 of FIG. 4, any record having the same event name “mouseout” is determined not to exist in the operation log 250 of FIG. 6.

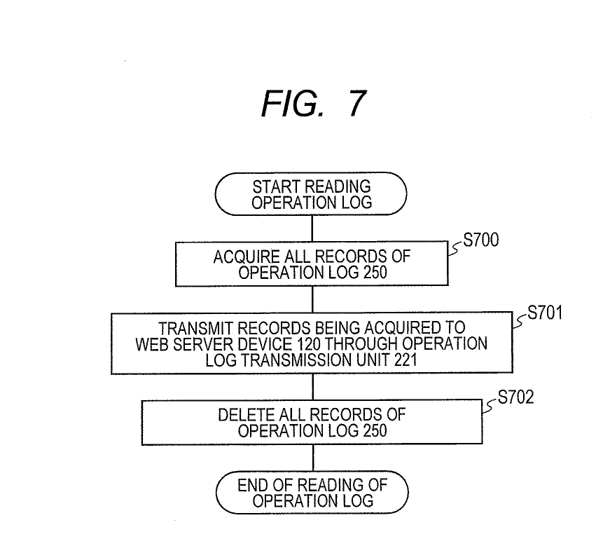

FIG. 7 shows a processing flow of the operation log reading unit 232.

First in step S700, all records of the operation log 250 are acquired. Next in step S701, the acquired records are transmitted to the Web server device 120 through the operation log transmission unit 221. Lastly in step S702, all records of the operation log 250 are deleted.

What has been described above is the typical process performed by the first embodiment of this invention.

The amount of log data can be reduced by determining whether or not it is necessary to record an event whenever it is acquired and by recording only the necessary events as the operation log.

### Second Embodiment

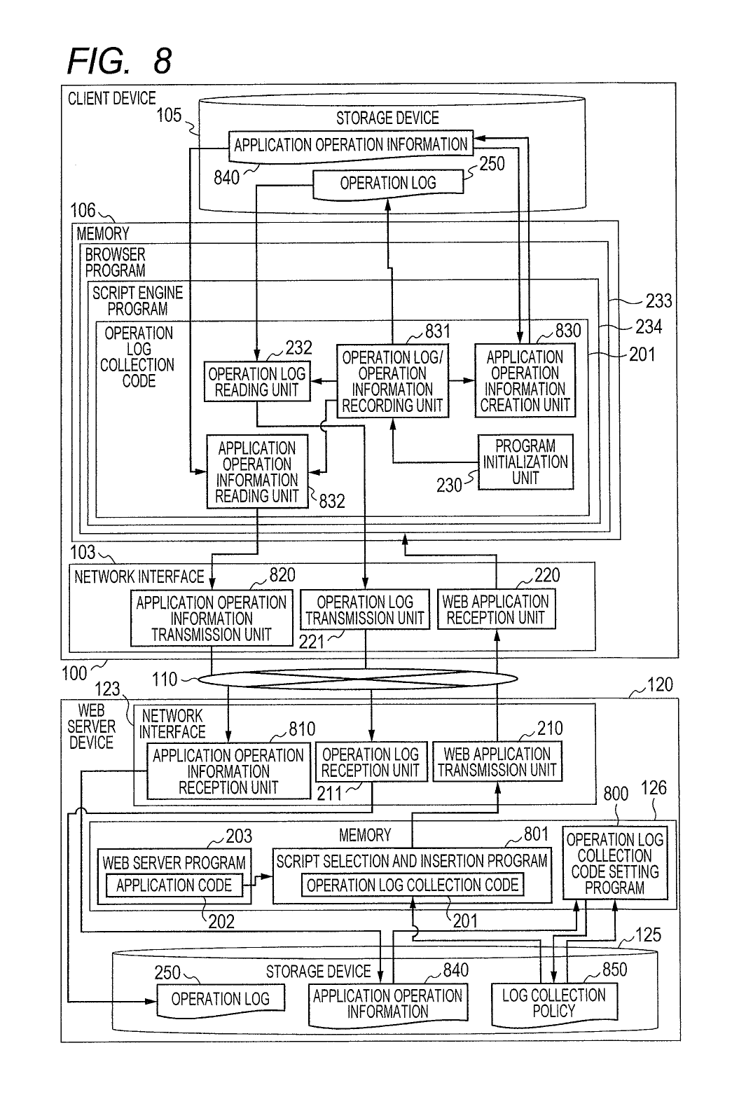

FIG. 8 is a block diagram showing a software configuration for selectively transmitting the amount of logs necessary and sufficient for reproducing client operations from event logs following establishment of a log collection policy.

Of the components configured in FIG. 8, those having the same names as their counterparts in FIG. 1 provide the same functions.

The memory 126 of the Web server device 120 stores an operation log collection code setting program 800 and a script selection and insertion program 801 in addition to the Web server program 203, application code 202, and operation log collection code 201.

Given a log collection policy 850 stored in the storage device 125, the operation log collection code setting program 800 has the function of creating a policy setting screen, causing the output device 121 in FIG. 1 to display the created screen, and accepting input settings through the input device 122 in FIG. 1 to update the log collection policy 850 accordingly.

The script selection and insertion program 801 has the function of receiving Web application responses from the Web server program 203, creating DOM element information from the responses, creating an event handler for handling all combinations of events and DOM elements described as the objects to be collected in the log collection policy 850, inserting the created event handler into a response to the Web application, and transmitting the event handler together with the response to the client device 100 through the Web application transmission unit 210.

The network interface 123 of the Web server device 120 is made up of an application operation information reception unit 810 in addition to the Web application transmission unit 210 and operation log reception unit 211.

The application operation information reception unit 810 has the function of receiving application operation information 840 from an application operation information transmission unit 820 of the client device 100 via the network 110 and storing the received information into the storage device 125.

Following receipt of the Web page response, the memory 106 of the client device 100 stores the browser program 233, script engine program 234, and operation log collection code 201.

The operation log collection code 201 is made up of an application operation information creation unit 830, an operation log/operation information recording unit 831, and an application operation information reading unit 832 in addition to the program initialization unit 230 and operation log reading unit 232, each unit being executed by the processor 104 in FIG. 1. These programs may be constituted alternatively by a plurality of programs having equivalent functions.

Given the events that occurred on the browser program 233, the application operation information creation unit 830 has the function of detecting any event determined to involve a data update or any event determined to have triggered event-driven script execution and of recording information about the events thus determined as the application operation information 840.

The operation log/operation information recording unit 831 has the function of detecting the events determined to involve data updates or the events determined to entail script execution from among the events having occurred on the browser program 233, and recording the detected events chronologically to the storage device 105 as the operation log 250. The operation log/operation information recording unit 831 also has the function of invoking the application operation information creation unit 830 whenever an event is determined to involve a data update or to entail event-driven script execution.

The application operation information reading unit 832 has the function of reading the application operation information 840 stored in the storage device 105 and transferring the retrieved information to the application operation information transmission unit 820. The application operation information 840 transmitted through the application operation information transmission unit 820 is recorded to the storage device 125 of the Web server device 120.

The network interface 103 of the client device 100 is made up of the application operation information transmission unit 820 in addition to the Web application reception unit 220 and operation log transmission unit 221.

The application operation information transmission unit 820 has the function of receiving the application operation information 840 from the application operation information reading unit 832 and transmitting the received information to the application operation information reception unit 810 of the Web server device 120 via the network 110.

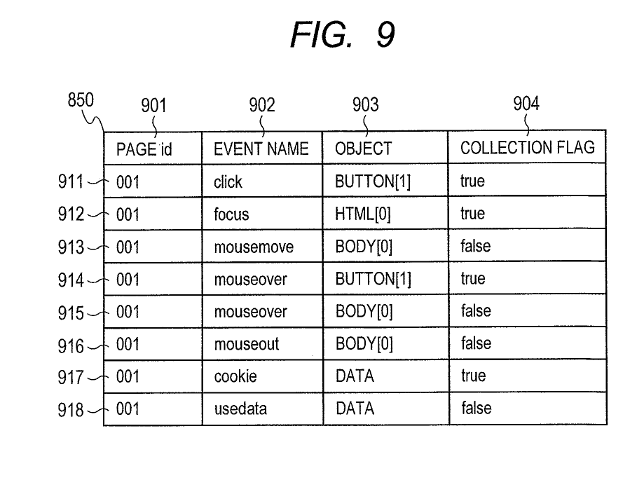

FIG. 9 shows a typical log collection policy 850 to be updated by the operation log collection code setting program 800.

The log collection policy 850 is an aggregate of records 911 through 918 representing the policy. The records 911 through 918 each have a page id 901, an event name 902, an object 903, and a collection flag 904 in their respective columns.

The page id 901 uniquely identifies each Web page to be collected for an operation log. Whereas three-digit integer values are listed in the page id column of FIG. 9, the id may also be a character string or a symbol as long as it uniquely identifies each Web page. For example, the page id may be implemented using the hash value of the URL of a given Web page.

The event name 902 is the name of each event to be collected. Some other suitable form of event name expression may also be used if it correctly identifies each event name.

The object 903 denotes the thing on which an event occurred. Whereas FIG. 9 lists Web page DOMs and data as typical objects, other objects may be adopted instead as something on which an event occurs. Some other suitable form of object expression may also be used if it correctly identifies the object.

The collection flag 904 denotes a Boolean value for use by the script selection and insertion program 801 in selecting the combination of a DOM element and an event that is to be granted an event handler. Whereas FIG. 9 lists “true” or “false” values as typical flags, some other suitable form of flag expression may be used instead if it correctly identifies the Boolean value.

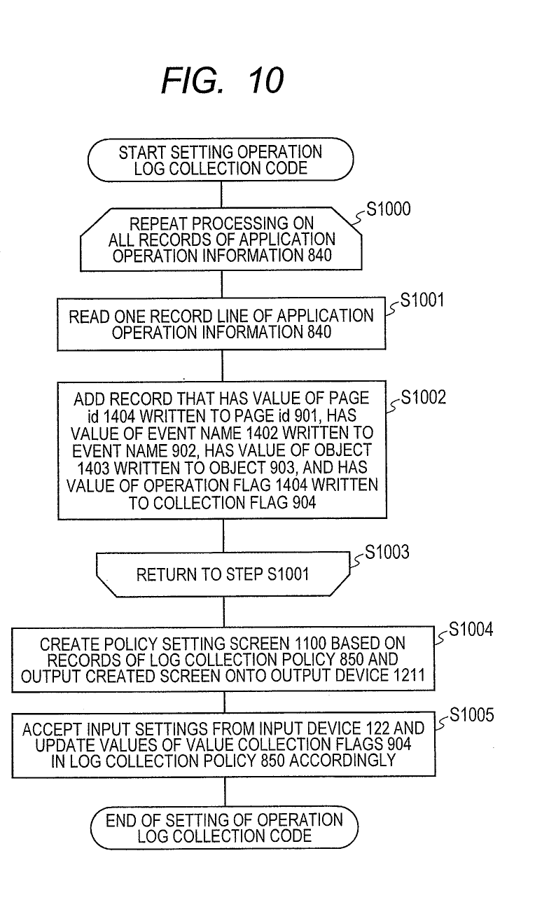

FIG. 10 shows a processing flow of the operation log collection code setting program 800.

First, as indicated in steps S1000 and S1003, the operation log collection code setting program 800 repeats steps S1001 and S1002 on all records of the application operation information 840.

In step S1001, one record line of the application operation information 840 is read. In step S1002, a record is added that has the value of a page id 1401 written to the page id 901, has the value of an event name 1402 to the event name 902, has the value of an object 1403 to the object 903, and has the value of an operation flag 1404 to the collection flag 904. Then in step S1004, a policy setting screen 1100 is created based on the records stored in the log collection policy 850 and is output onto the output device 121. Lastly, input settings from the input device 122 are accepted and the values of the collection flag 904 in the log collection policy are updated accordingly. By creating the policy setting screen 1100 using the application operation information 840, the user can establish a log collection policy for collecting log data from the applications operating on the client device, the collected log data being used to reproduce client operations.

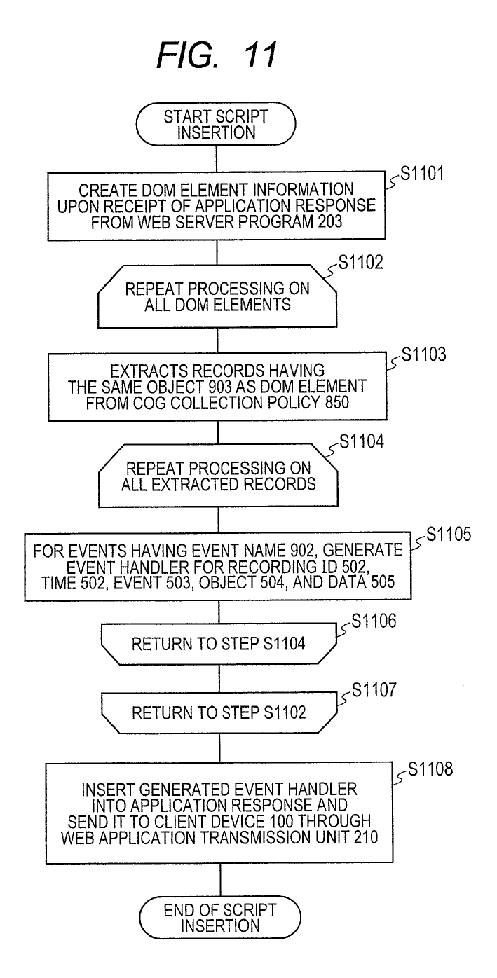

FIG. 11 shows a processing flow of the script selection and insertion program 801.

First in step S1101, application responses are received from the Web server program 203 and DOM element information is thereby created. This process may be implemented using a node acquisition function possessed by the DOM object, for example. The subsequent process is then repeated on all created DOM elements as indicated in steps S1102 and S1107.

First in step S1103, records having the same object as the DOM element are extracted as per the log collection policy 850. Then the process of step S1105 is repeated on all extracted records as indicated in step S1104 and S1106. In step S1105, an event handler for recording the ID 501, time 502, event 503, object 504, and data 505 is created regarding the events having the event name 902. The process of recording the object 504 may be implemented using a target path acquisition function possessed by an event, for example. The process of recording the data 505 may be implemented by referencing the properties possessed by an event, for example. Lastly in step S1108, the generated event handler is inserted into a response to the application and transmitted along with the response to the client device 100 through the Web application transmission unit 210.

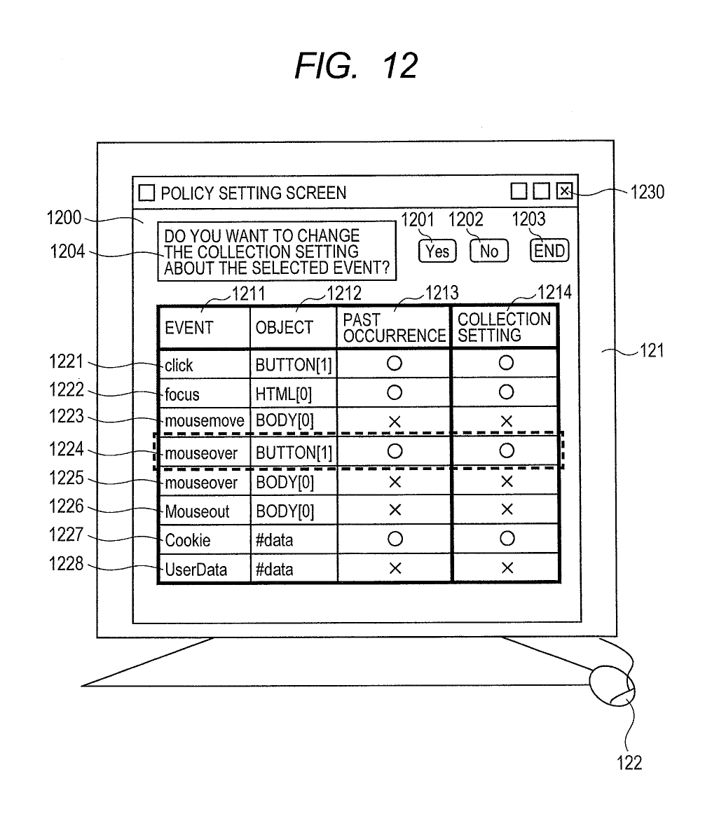

In this manner, the client device collects the log data about the events designated in the log collection policy. FIG. 12 shows a policy setting screen 1200 constituting a user interface through which the log collection policy 850 is established.

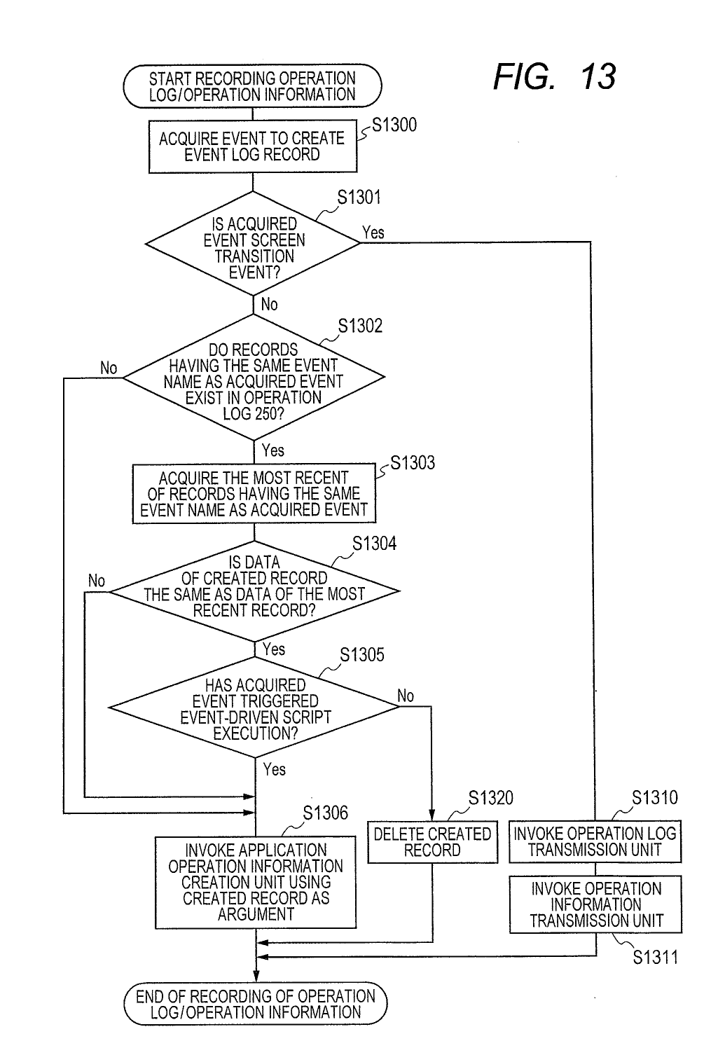

The policy setting screen 1200 is a window that aggregates user interfaces for setting policies. Records 1221 through 1228 are the same as those of the log collection policy. An event 1211 and an object 1212 denote the event name 902 and the object 903, respectively. A past occurrence 1213 gives a Boolean value indicating whether the event denoted by the event name 1211 has occurred on the object indicated by the object 1212 before being stored as an operation log in step S1306 of FIG. 13. For example, the record 1224 indicates an event “mouseover” that occurred in the past on an object “BUTTON[1]” before being recorded as an operation log. A collection setting 1214 denotes the value of the collection flag 904 to be set subsequent to the setting process on this screen. For example, the record 1224 indicates that a value “◯” is set in the collection setting 1214 and that the collection flag 904 is set to “true” upon completion of this setting. Whereas the form of expression is “◯,” “X” for the past occurrence 1213 and collection setting 1214, some other suitable form of expression may be used instead as long as it can identify the Boolean value.

A verification indication 1204 is a character string that requests verification of any change to be made by the user's input in the value of the collection setting 1214. When presented with this character string, the user may press an enter button 1201 if wanting to actually make the change and a cancel button 1202 if not really wanting to make the change. Incidentally, the verification indication 1204, enter button 1201, and cancel button 1202 may be in other suitable forms of expression if they provide the function of requesting verification and consent from the user. If the function of requesting verification is not necessary, the verification indication 1204, enter button 1201, and cancel button 1202 may be omitted.

When wanting to terminate the setting of the log collection policy 850, the user need only press a close button 1230 or an end button 1203. The close button 1230 and end button 1203 may be in other suitable forms if they provide similar functions.

FIG. 13 shows a processing flow of the operation log/operation information recording unit.

First in step S1300, an event that occurred is acquired and an event log record is created. In step S1301, it is determined whether the acquired event is a screen transition event. If the event that occurred is determined to be a screen transition event, the operation log transmission unit 221 is invoked in step S1310 and the operation information transmission unit 820 is invoked in step S1311. Then this process is terminated.

If the event that occurred is determined not to be a screen transition event, step S1302 is reached. In step S1302, it is determined whether any record having the same event name as the acquired event exists in the operation log 250. If any record having the same event name as the acquired event is determined not to exist, step S1306 is reached. In step S1306, the application operation information creation unit 830 is invoked using a newly created record as an argument. Then this process is terminated.

If records having the same event name as the acquired event are determined to exist, step S1303 is reached. In step S1303, the most recent of the records having the same event name is acquired.

Next in step S1304, it is determined whether the data 505 of the acquired record is the same as the data 505 of the record created in step S1303. If the two bodies of data are determined to be different, step S1306 is reached. In step S1306, the application operation information creation unit 830 is invoked using the created record as an argument. Then this process is terminated.

If the two bodies of data are determined to be the same, step S1305 is reached. In step S1305, it is determined whether the acquired event has triggered event-driven script execution. If event-driven script execution is determined to have occurred, step S1306 is reached. In step S1306, the application operation information creation unit 830 is invoked using a newly created record as an argument. Then this process is terminated.

If event-driven script execution is determined not to have occurred, step S1320 is reached and the created record is deleted. When the determinations are made in steps S1302, S1304 and S1305 as described above, the record not needed for client operation reproduction can be deleted in step S1320. It is determined whether the event of interest is of the type already recorded in the operation log in step S1302, whether the event of the already recorded type has no data change in step S1304, and whether the event of the type already recorded in the operation log with no data change has triggered script execution in step S1305. In this manner, the Web server device can reproduce client operations while the amount of logs to be stored in the client device preparatory to log data transmission to the Web server device is reduced.

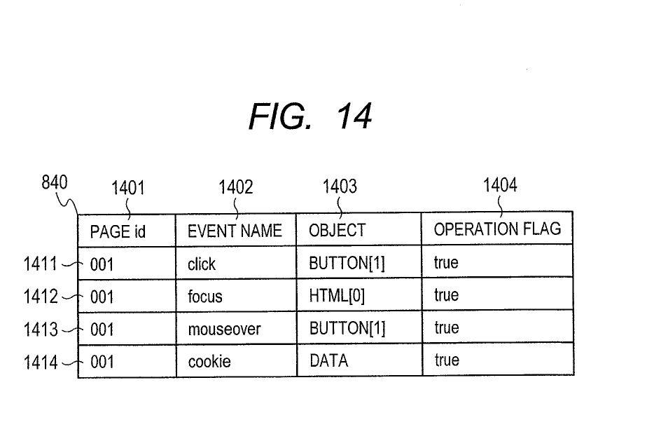

FIG. 14 shows typical application operation information 840 created by the application operation information creation unit 830.

The application operation information 840 is an aggregate of records 1411 through 1414 each indicating whether a date update has occurred or whether event-driven script execution has taken place. The records 1411 through 1414 each have a page id 1401, an event name 1402, an object 1403, and an operation flag 1404 in their respective columns.

The page id 1401 uniquely identifies each Web page on which application operation information is recorded. As such, the page id 1401 is created in the same manner as the page id 903 for the log collection policy 850. Whereas three-digit integer values are listed in the page id column of FIG. 14, the id may also be a character string or a symbol as long as it uniquely identifies each Web page.

The event name 1402 denotes the name of each event that has occurred, and is created in the same manner as the event name 503 when the operation log 250 is created. Some other suitable form of event name expression may also be used if it correctly identifies each event name.

The object 1403 denotes the thing on which an event occurred, and is created in the same manner as the object 504 when the operation log 250 is created. Whereas FIG. 14 lists Web page DOMs and data as typical objects, other objects may be recorded. Some other suitable form of object expression may also be used if it correctly identifies the object.

The operation flag 1404 denotes a Boolean value for use by the operation log collection code setting program 800 in creating the policy setting screen 1200 and indicates whether a date update has occurred or whether event-driven script execution has taken place in the record. Whereas FIG. 14 lists “true” or “false” values as typical flags, some other suitable form of flag expression may be used instead if it correctly identifies the Boolean value.

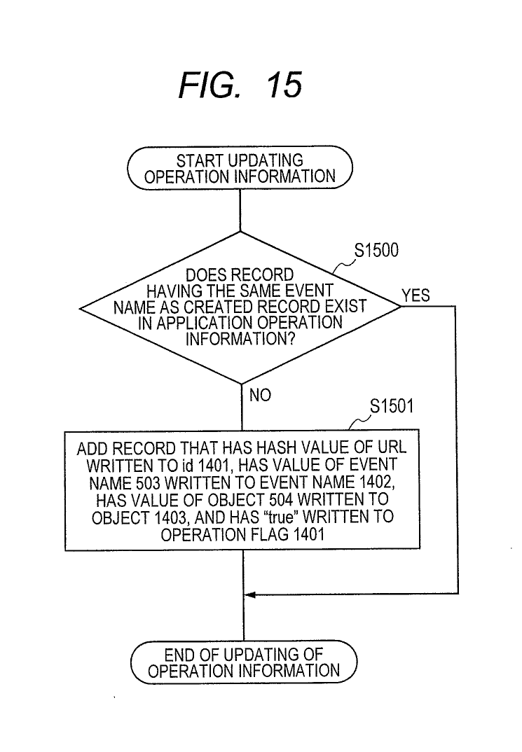

FIG. 15 shows a flow of an operation information updating process performed by the application operation information creation unit 830.

In step S1500, it is determined whether any record having the same event name as the record created in step S1300 exists in the application operation information 840. If any such record is determined to exist, this process is terminated.

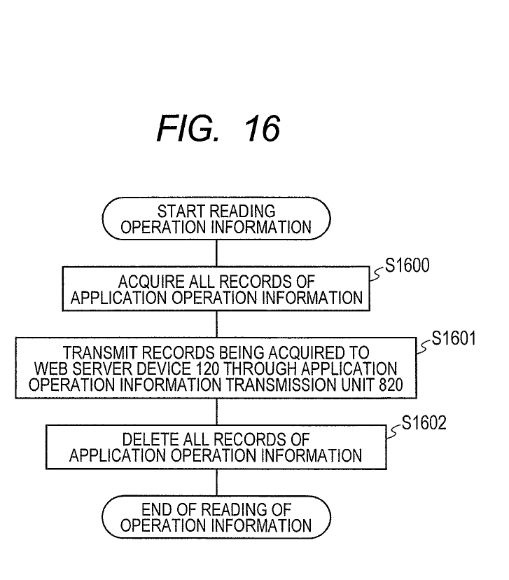

If any such record is determined not to exist, step S1501 is reached. In step S1501, a record that has the hash value of the URL is added to the page id column 1401, a record that has the value of the event name 503 is added to the event name column 1402, a record that has the value of the object 504 is added to the object column 1403, and a record that has a “true” is added to the operation flag column 1404. FIG. 16 shows a processing flow of the application operation information output unit 832.

First in step S1600, all records of the application operation information 840 are acquired. Then in step S1601, the acquired records are transmitted to the Web server device 120 through the application operation information transmission unit 820. This allows the Web server device 120 to recognize the applications operating on the client device. As a result, the user can set a log collection policy for collecting log data from the applications operating on the client device, the log data being collected to reproduce client operations. Lastly in step S1602, all records of the application operation information 840 are deleted.

What has been described above is the typical process performed by the second embodiment of this invention.

The amount of log data can be reduced by determining whether or not it is necessary to record an event whenever it is acquired and by recording only the necessary events as the operation log. Furthermore, when the setting operator (i.e., user) is furnished with means for setting the events to be acquired and with the results of the data necessity determinations acquired from the operation information, it is possible to make accurate settings with a minimum of effort.

### REFERENCE SIGNS LIST

100 Client device
120 Web server device
101, 121 Output device
102, 122 Input device
103, 123 Network interface
104, 124 Processor
105, 125 Storage device
106, 126 Memory
100 Network
200 Script insertion program
201 Operation log collection code
202 Application code
203 Web server program
210 Web application transmission unit
211 Operation log reception unit
220 Web application reception unit
221 Operation log transmission unit
230 Program initialization unit
231 Operation log recording unit
232 Operation log output unit
233 Browser program
234 Script engine program
235 Operation log collection code
240 Event log
250 Operation log
800 Operation log collection code setting program
801 Script selection and insertion program
810 Application operation information reception unit
820 Application operation information transmission unit
830 Application operation information creation unit
831 Operation log recording unit
832 Application operation information output unit
840 Application operation information
850 Log collection policy
1200 Log collection policy setting window
1201 Enter button
1202 Cancel button
1203 End button
1204 Verification indication
1230 Close button

1. An operation log collection method for recording operation information on Web applications, the operation log collection method comprising:
a program initialization step of building into a browser an event acquisition means for detecting an event upon reading a Web application and for acquiring the detected event;
an operation log recording step which, upon acquisition of the event by the event acquisition means, determines whether it is necessary to record the acquired event and which records a log of the event of which the recording is determined to be necessary, and
an operation log output step of outputting the log of the events recorded in the operation log recording step.

2. An operation log collection method according to claim 1, wherein, upon acquisition of the event, the operation log recording step determines whether there is a data update in the acquired event and records the log of the event determined to have data updated therein.

3. An operation log collection method according to claim 1, wherein, upon acquisition of the event, the operation log recording step determines whether the acquired event has triggered event-driven script execution and records the event that has entailed the event-driven script execution.

4. An operation log collection method according to claim 1, wherein, based on an acquisition object event list holding types of the event as objects to be acquired, the program initialization step regards as an object to be acquired the event of which the type is retained in the acquisition object event list;
the operation log collection method further comprising:
an operation information creation step of recording as operation information the type of the event recorded in the operation log recording step;
an operation information output step of outputting to the outside the operation information recorded in the operation information creation step, and
an acquisition object event list setting step of creating the acquisition object event list based on at least one body of the operation information output in the operation information output step.

5. An operation log collection method according to claim 4, wherein the acquisition object event list setting step regards a list holding at least one event type included in at least one body of the operation information as the initial value of the acquisition object event list, and
wherein the acquisition object event list setting step expands the event types as the objects to be acquired based on at least one body of the operation information output in the operation information output step.

6. An operation log collection device for recording an operation log of Web applications, the operation log collection device comprising:
a program initialization unit which builds into a browser an event acquisition means for detecting an event upon reading a Web application and for acquiring the detected event;
an operation log recording unit which, upon acquisition of the event by the event acquisition means, determines whether it is necessary to record the acquired event and which records a log of the event of which the recording is determined to be necessary, and
an operation log output unit which outputs the log of the events recorded by the operation log recording unit.

7. An operation log collection device according to claim 6, wherein, upon acquisition of the event, the operation log recording unit determines whether there is a data update in the acquired event and records the log of the event determined to have data updated therein.

8. An operation log collection method according to claim 6, wherein, upon acquisition of the event, the operation log recording unit determines whether the acquired event has triggered event-driven script execution and records the event that has entailed the event-driven script execution.

9. An operation log collection device according to claim 6, wherein, based on an acquisition object event list holding types of the event as objects to be acquired, the program initialization unit regards as an object to be acquired the event of which the type is retained in the acquisition object event list;
the operation log collection device further comprising:
an operation information creation unit which records as operation information the type of the event recorded by the event recording unit, and
an operation information output unit which outputs to the outside the operation information recorded by the operation information creation unit.

10. An operation log collection device according to claim 7, wherein, based on an acquisition object event list holding types of the event as objects to be acquired, the program initialization unit regards as an object to be acquired the event of which the type is retained in the acquisition object event list;
the operation log collection device further comprising:
an operation information creation unit which records as operation information the type of the event recorded by the event recording unit, and
an operation information output unit which outputs to the outside the operation information recorded by the operation information creation unit.

11. A server device for collecting an operation log of Web applications, the server device retaining an acquisition object event list holding types of events as objects to be acquired for the log, the server device comprising:
an acquisition object event list setting unit which, based on operation information about the Web applications, sets the acquisition object event list.

12. A server device according to claim 11, wherein the acquisition object event list setting unit regards a list holding at least one event type included in one or more body of the operation information as the initial value of the acquisition object event list, and
wherein the acquisition object event list setting unit expands the event types as the objects to be acquired.
